(19) United States
(12) Patent Application Publication
(10) Pub. No.: US 2026/0337383 A1
(43) Pub. Date: Oct. 29, 2026

(54) MOLDING MATERIAL AND METHOD FOR PRODUCING MOLDING MATERIAL

(71) Applicant: SEIKO EPSON CORPORATION, Tokyo (JP)

(72) Inventors: Tomohiro FUJITA, Matsumoto (JP); Kiyoaki SAKAGUCHI, Suwa (JP); Junsei AOKI, Chino (JP); Soya HAYASHI, Suwa (JP); Yuta HINO, Chino (JP); Oshi IWAKAMI, Chino (JP)

(21) Appl. No.: 19/574,571

(22) Filed: Mar. 23, 2026

(30) Foreign Application Priority Data
Mar. 24, 2025 (JP) 2025-048836

(51) Int. Cl. C08L 1/02; C08L 67/04

(52) U.S. Cl. CPC C08L 1/02; C08L 67/04; C08L 2205/025; C08L 2205/03; C08L 2205/035

(57) ABSTRACT

Provided is a molding material containing an elastomer, a highly polar polyester, and a cellulose-based filler. The elastomer is dispersed such that an average short side length A of the elastomer in an arbitrary cross section of the molding material is 2 μm or less, and a ratio L/A of an area-weighted average perimeter L to the average short side length A of the elastomer is 60 to 200.

The present application is based on, and claims priority from JP Application Serial Number 2025-048836, filed Mar. 24, 2025, the disclosure of which is hereby incorporated by reference herein in its entirety.

### BACKGROUND

### 1. Technical Field

The present disclosure relates to a molding material and a method for producing a molding material.

### 2. Related Art

JP-A-2005-272783 discloses a natural fiber-reinforced polyester material containing an aliphatic polyester, an elastomer, and pulp.

The molding material described in JP-A-2005-272783 has room for improvement in achieving both excellent impact resistance (toughness and tenacity) and elasticity (rigidity and resistance to deformation) when made into a molded article.

### SUMMARY

A molding material of the present disclosure is a molding material containing an elastomer, a highly polar polyester, and a cellulose-based filler, wherein the elastomer is dispersed such that an average short side length A of the elastomer in an arbitrary cross section of the molding material is 2 μm or less, and a ratio L/A of an area-weighted average perimeter L to the average short side length A of the elastomer is 60 to 200.

A method for producing a molding material of the present disclosure includes a kneading step of kneading an elastomer, a highly polar polyester, and a cellulose-based filler to obtain a molding material, wherein in the kneading step, the elastomer is dispersed such that an average short side length A of the elastomer in an arbitrary cross section of the molding material is 2 μm or less, and a ratio L/A of an area-weighted average perimeter L to the average short side length A of the elastomer is 60 to 200.

### BRIEF DESCRIPTION OF THE DRAWINGS

FIG. 1 is an atomic force microscope image for explaining a measurement procedure.

FIG. 2 is a binarized image for explaining the measurement procedure.

FIG. 3 is an example of a binarized image based on a composite modulus.

FIG. 4 is an example of the binarized image based on the composite modulus.

FIG. 5 is an example of the binarized image based on the composite modulus.

FIG. 6 is an example of the binarized image based on the composite modulus.

FIG. 7 is a table showing results of Examples.

### DESCRIPTION OF EMBODIMENTS

Hereinafter, an embodiment of the present disclosure (hereinafter, referred to as “the present embodiment”) will be described in detail with reference to the drawings as needed, but the present disclosure is not limited thereto, and various modifications can be made within a range not departing from the scope of the present disclosure. In the drawings, the same elements are denoted by the same reference numerals and the repetitive description will be omitted. In addition, positional relationships such as up, down, left, and right are based on the positional relationships shown in the drawings unless otherwise specified. Furthermore, the dimensional ratios in the drawings are not limited to the ratios shown in the drawings.

### 1. Molding Material

The molding material of the present embodiment is a molding material containing an elastomer, a highly polar polyester, and a cellulose-based filler, wherein the elastomer is dispersed such that an average short side length A of the elastomer in an arbitrary cross section of the molding material is 2 μm or less, and a ratio L/A of an area-weighted average perimeter L to the average short side length A of the elastomer is 60 to 200.

As a result of intensive studies on the physical properties of a molding material in which a cellulose-based filler and an elastomer are compounded, the present inventors have found that, in the case of a sea-island structure in which the elastomer is dispersed as islands that are relatively thin and have a considerable length in the molding material, both the impact resistance (toughness and tenacity) and the elasticity (rigidity and resistance to deformation) are improved as compared with the case of a sea-island structure in which the elastomer is dispersed as fine particulate islands or a sea-island structure in which the elastomer spreads like a sea.

Given these circumstances, the present embodiment provides that the average short side length A of the elastomer is 2 μm or less, and the ratio L/A of the area-weighted average perimeter L to the average short side length A of the elastomer is 60 to 200 in order to show the state in which the elastomer is dispersed as islands that are relatively thin and have a considerable length.

When the average short side length A of the elastomer in an arbitrary cross section of the molding material is 2 μm or less, the elastomer is finely dispersed in the molding material such that the thickness is small to some extent, and both the impact resistance and the elasticity when made into a molded article tend to be improved. The average short side length A serves as an index of the thickness of the dispersed elastomer, and it can be said that the larger the average short side length A is, the larger the thickness of the elastomer is.

When the ratio L/A of the area-weighted average perimeter L to the average short side length A of the elastomer in an arbitrary cross section of the molding material is 60 or more, the elastomer is dispersed in the molding material so as to spread with predetermined continuity or more, and when impact is applied to the molded article, the impact is dispersed, and stress concentration on the interface between the elastomer and the cellulose-based filler is relieved. As a result, interfacial peeling between the elastomer and the cellulose-based filler is inhibited, and thus the impact resistance of the molded article tends to be improved. The ratio L/A is an index of the continuity of the dispersed elastomer, and it can be said that the larger the ratio L/A is, the larger the continuity of the elastomer is.

When the ratio L/A is 200 or less, the elastomer is inhibited from spreading into a sea-like state, and the highly polar polyester and the cellulose-based filler, which contribute to an improvement in the elasticity, can form a skeleton of a sea-like continuous structure, so that the elasticity when made into the molded article tends to be improved.

For the above reasons, it is considered that when the average short side length A of the dispersed elastomer is 2 μm or less, and the ratio L/A is 60 to 200, both the impact resistance and the elasticity of the molded article are achieved at a high level. The mechanism for exhibiting the effect of the present embodiment is not limited thereto.

### 1.1. Elastomer

The elastomer serves as a resin matrix, and mainly ensures the impact resistance of the molded article. The elastomer is preferably thermoplastic from the viewpoint of moldability. When the molded article is produced from the molding material, the thermoplastic elastomer melts to bind the cellulose-based filler.

The content of the elastomer is preferably 10 to 45% by mass, 15 to 40% by mass, or 20 to 35% by mass with respect to the total amount of the molding material. When the content of the elastomer is within the above range, the impact resistance and the elasticity of the molded article tend to be further improved.

Examples of the elastomer include a polyester-based elastomer, an olefin-based elastomer, a polystyrene-based elastomer, a polyvinyl chloride-based elastomer, a polyurethane-based elastomer, and a polyamide-based elastomer. Among these, a polyester-based elastomer or an olefin-based elastomer is preferable.

### 1.1.1. Polyester-Based Elastomer

The polyester-based elastomer has a possibility of being produced and utilized as a bioplastic in the future, and is also a material expected to promote the reduction of environmental load.

The polyester-based elastomer preferably contains, as raw material monomers, an alkyldicarboxylic acid with an alkylene group having 2 or more and 8 or less carbon atoms or phthalic acid and an alkylene diol with an alkylene group having 2 or more and 8 or less carbon atoms. When the polyester-based elastomer contains the above raw material monomers, the impact resistance tends to be improved.

Examples of the alkyldicarboxylic acid include linear saturated aliphatic dicarboxylic acids such as succinic acid, glutaric acid, adipic acid, pimelic acid, suberic acid, azelaic acid, and sebacic acid. These alkyldicarboxylic acids may have a substituent in the molecular structure. For the synthesis of the polyester-based elastomer, it is preferable to use one or more of these.

The phthalic acid may have a substituent in the molecular structure.

Examples of the alkylene diol include 1,2-ethanediol, 1,3-propanediol, 1,4-butanediol, 1,5-pentanediol, 1,6-hexanediol, 1,7-heptanediol, and 1,8-octanediol. For the synthesis of the polyester-based elastomer, it is preferable to use one or more of these.

The alkyldicarboxylic acid, phthalic acid and the alkylene diol described above are relatively easily available and can be used in industrial or commercial applications.

The polyester-based elastomer may contain other raw material monomers in addition to the above-described raw material monomers. Examples of the other raw material monomers include styrene, butadiene, acrylic acid, acrylate, methacrylic acid, methacrylate, acetonitrile, isobutylene, isoprene, and ethylene, and one or more of these are preferably used. By containing such other raw material monomers, the impact resistance tends to be improved.

When the other raw material monomers are incorporated into the polyester-based elastomer, the total number of moles of the other raw material monomers is preferably 1% or more and less than 50% with respect to the total number of moles of the raw material monomers. As a result, the impact resistance tends to be improved.

A commercially available product may be used as the polyester-based elastomer. Examples of the commercially available product of the polyester-based elastomer include the Esterar ES series such as ES-A60NX (manufactured by Aronkasei Co., Ltd.) and the Esterar E series such as E-D27N and E-D42N (manufactured by Aronkasei Co., Ltd.).

### 1.1.2. Olefin-Based Elastomer

The olefin-based elastomer is not particularly limited, and is preferably ethylene propylene diene rubber (EPDM). Examples of the commercially available product of the ethylene propylene diene rubber (EPDM) include NOLDEL 3720P (manufactured by Dow Toray Co., Ltd.).

### 1.1.3. Analysis of Presence or Absence and Kind of Elastomer

In an arbitrary cross section of the molding material, the presence or absence of the elastomer can be determined based on the presence or absence of a component having a composite modulus of 100 MPa or less. Specifically, for example, the cross section of the molding material is measured in a contact mode using a scanning probe microscope NX20 manufactured by Park Systems Japan Inc. When it is confirmed in this measurement that component having a composite modulus of 100 MPa or less is contained, the component is determined to be the elastomer. A known nano-indentor may be used to determine the presence or absence of the elastomer.

The kind of the elastomer can be determined by component analysis. For example, the kind of the elastomer can be determined by qualitative analysis using both a pyrolysis gas chromatography-mass spectrometry (GC-MS) method and a Fourier transform infrared spectroscopy (FT-IR). The pyrolysis GC-MS method is an analysis method for identifying various fragments generated by pyrolyzing a sample. In the pyrolysis GC-MS method, for example, Multi-Shot Pyrolyzer EGA/PY-3030D from Frontier Laboratories Ltd. and GC/MS 5975 from Agilent Technologies, Inc. equipped with the apparatus can be used. The FT-IR method is an analysis method for identifying the molecular structure of a sample from an infrared absorption spectrum of the sample. For the FT-IR method, for example, Nicolet (registered trademark) 380 Continuμm (registered trademark) from Thermo Fisher Scientific Inc. can be used. By these analyses, the molecular structure of the elastomer can be identified to determine the kind of the elastomer.

### 1.1.4. Dispersed State of Elastomer

The elastomer according to the present embodiment is dispersed such that the average short side length A of the elastomer in an arbitrary cross section of the molding material is 2 μm or less, and the ratio L/A of the area-weighted average perimeter L to the average short side length A of the elastomer is 60 to 200. As a result, both the impact resistance and the elasticity of the molded article obtained from the molding material of the present embodiment are achieved at a high level.

The average short side length A of the elastomer is preferably 0.5 μm or more, 0.7 μm or more, 0.9 μm or more, or 1.0 μm or more. The average short side length A of the elastomer is preferably 1.9 μm or less, 1.8 μm or less, or 1.7 μm or less. When the average short side length A is within the above range, both the impact resistance and the elasticity of the molded article obtained from the molding material of the present embodiment tend to be achieved at a higher level.

The area-weighted average perimeter L of the elastomer is preferably 100 μm or more, 110 μm or more, or 120 μm or more. The area-weighted average perimeter L of the elastomer is preferably 200 μm or less, 180 μm or less, 160 μm or less, or 150 μm or less. When the area-weighted average perimeter L is within the above range, both the impact resistance and the elasticity of the molded article obtained from the molding material of the present embodiment tend to be achieved at a higher level.

The ratio L/A of the elastomer is preferably 70 or more, 80 or more, or 90 or more. The ratio L/A of the elastomer is preferably 180 or less, 160 or less, or 150 or less. When the ratio L/A is within the above range, both the impact resistance and the elasticity of the molded article obtained from the molding material of the present embodiment tend to be achieved at a higher level.

The average short side length A and the area-weighted average perimeter L of the elastomer are controlled by, for example, the kind and content of the elastomer, the kind and content of components other than the elastomer, kneading conditions, and the like. The kneading conditions include the kind of a kneader, a kneading temperature, an extrusion discharge amount, and the number of times of kneading. For example, by increasing the content of the elastomer, the ratio L/A tends to increase. For example, by increasing the number of times of kneading, both the average short side length A and the area-weighted average perimeter L of the elastomer tend to decrease. In addition, since the area-weighted average perimeter L tends to have a larger degree of decreasing by kneading than the average short side length A, the ratio L/A also tends to decrease by increasing the number of times of kneading.

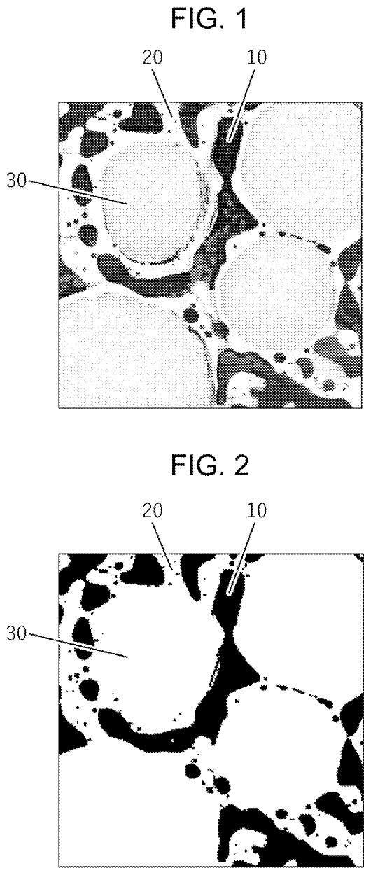

The average short side length A and the area-weighted average perimeter L of the elastomer can be measured from an image obtained by photographing an arbitrary cross section of the molding material by using image processing software. Specifically, for example, the measurement can be performed by the following procedure using ImageJ (developer: National Institutes of Health (NIH)), which is image processing software. It is noted that FIG. 1 and FIG. 2 used in the following description are images for explaining the measurement procedure, and are not necessarily images of the molding material of the present embodiment.

### Procedure 1: Acquisition of Atomic Force Microscope Image of Cross Section

To perform shape evaluation on an elastomer portion, the molding material is cut to obtain an arbitrary cross section. This cross section is photographed with an atomic force microscope to acquire an atomic force microscope image. As a result, the atomic force microscope image illustrated in FIG. 1 is obtained. In the atomic force microscope image of FIG. 1, an elastomer 10, a filler 20, and a highly polar polyester 30 are shown. The filler 20 is, for example, a cellulose-based filler or an inorganic filler.

### Procedure 2: Creation of Binarized Image of Cross Section

Using image analysis software such as ImageJ, the atomic force microscope image data obtained as described above is binarized by threshold processing. As a result, the binarized image illustrated in FIG. 2 is obtained. At this time, noise reduction processing or adjustment of clarity may be performed prior to the binarization processing so that the elastomer portion is extracted by the binarization processing. As a result, a clear outline of the elastomer portion can be obtained in the atomic force microscope image.

### Procedure 3: Calculation of Area-Weighted Average Perimeter L

To calculate the area-weighted average perimeter L, which is one of the shape parameters of the elastomer portion, first, the area and the perimeter of each elastomer portion are measured using image analysis software such as ImageJ. Based on the measured area and perimeter data, the area-weighted perimeter of each elastomer portion is calculated using the following expression. The calculation results are totaled, and the total value of the area-weighted perimeters of all elastomer portions is determined as the area-weighted average perimeter L. As a result, the overall shape characteristics of the elastomer portion are evaluated.

area-weighted perimeter of each elastomer portion=perimeter of each elastomer portion×area of each elastomer portion/(total of areas of all elastomer portions) <Expression>

### Procedure 4: Calculation of Average Short Side Length A

Subsequently, the average short side length A is calculated. First, a linear feature extraction function of image analysis software such as ImageJ is used to detect the short side of the elastomer portion. The length of the detected short side is defined as a short side length, and an average of this short side length is calculated as the average short side length A. If the length of the detected short side is smaller than the length of 1 pixel, after going through processing to exclude it from the short side length data as noise, the average short side length A may be calculated.

By Procedures 1 to 4 above, the average short side length A and the area-weighted average perimeter L of the elastomer can be measured. Further, the ratio L/A can be determined by calculating the ratio of the area-weighted average perimeter length L to the average short side length A.

During the observation using the atomic force microscope, a binarized image in which a portion where the composite modulus is 100 MPa or less is black and a portion where the composite modulus is greater than 100 MPa is white may be created, and this may be used instead of Procedures 1 and 2 above.

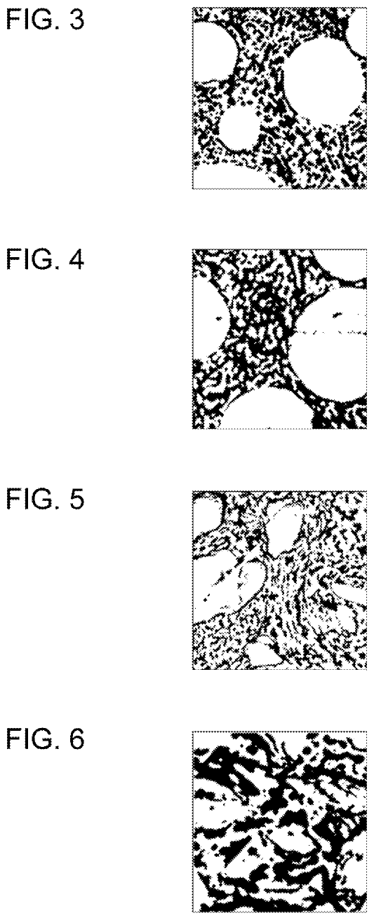

FIG. 3 to FIG. 6 are examples of the binarized image in which a portion where the composite modulus is 100 MPa or less is black and a portion where the composite modulus is greater than 100 MPa is white. It is noted that FIG. 3 to FIG. 6 are not necessarily images of the molding material of the present embodiment.

In the example shown in FIG. 3, the average short side length A is 0.7 μm, the area-weighted average perimeter L is 21.2 μm, and the ratio L/A is 31.1.

In the example shown in FIG. 4, the average short side length A is 1.2 μm, the area-weighted average perimeter length L is 539.4 μm, and the ratio L/A is 434.1.

In the example shown in FIG. 5, the average short side length A is 0.9 μm, the area-weighted average perimeter length L is 167.1 μm, and the ratio L/A is 183.4.

In the example shown in FIG. 6, the average short side length A is 1.6 μm, the area-weighted average perimeter length L is 249.3 μm, and the ratio L/A is 158.1.

### 1.2. Highly Polar Polyester

The highly polar polyester refers to an aliphatic polyester in which the number of oxygen atoms is 1 or more with respect to 2 carbon atoms in a repeating structure derived from a raw material monomer, and has a molecular structure having relatively high polarity. The highly polar polyester has thermoplasticity, and when a molded article is produced from the molding material, the highly polar polyester melts to bind the cellulose-based filler. In addition, the elastomer and the cellulose-based filler have low compatibility and are likely to cause interfacial peeling, but the highly polar polyester functions as a compatibilizer for the elastomer and the cellulose-based filler, and can inhibit interfacial peeling. Further, the highly polar polyester tends to improve the elasticity of the molded article.

The highly polar polyester preferably contains, as the raw material monomer, lactic acid, hydroxybutyric acid, oxysuccinic acid, citric acid, malonic acid, succinic acid, serine, threonine, acrylic acid, methyl acrylate, vinyl acetate, or the like.

The highly polar polyester preferably contains one or more of polylactic acid, polyhydroxybutyric acid, polyacrylic acid, polymethyl acrylate, polyvinyl acetate, and the like. The highly polar polyester may be a copolymer having a structure derived from lactic acid or acetic acid in the molecular structure, such as polyethylene succinic acid. Among these, the highly polar polyester preferably contains one or more of polylactic acid and polyhydroxybutyric acid. Since polylactic acid and polyhydroxybutyric acid have biodegradability, they can reduce environmental load.

The highly polar polyester particularly preferably contains polylactic acid. As a result, interfacial peeling between the elastomer and the cellulose-based filler tends to be further inhibited. Examples of the commercially available product of polylactic acid include Terramac TE-2000 (manufactured by Unitika Ltd.).

The weight average molecular weight of the highly polar polyester is not particularly limited, and may be 5,000 or more, 10,000 or more, or 50,000 or more. The weight average molecular weight of the highly polar polyester may be 200,000 or less, 150,000 or less, or 100,000 or less.

The content of the highly polar polyester is preferably 20 to 60% by mass, 25 to 55% by mass, 30 to 50% by mass, or 35 to 45% by mass with respect to the total amount of the molding material. When the content of the highly polar polyester is within the above range, the impact resistance and the elasticity of the molded article tend to be further improved.

### 1.3. Cellulose-Based Filler

The cellulose-based filler functions as a filling material in the molding material and the molded article. In addition, the cellulose-based filler tends to improve the elasticity of the molded article. The cellulose-based filler is derived from plants and is a relatively abundant natural material. Therefore, by using the cellulose-based filler, environmental load can be reduced as compared with a case of using a filling material obtained by synthesis. The cellulose-based filler is advantageous also in terms of procurement of raw materials and cost.

The shape of the cellulose-based filler may be fibrous, scaly, or spherical. As the cellulose-based filler, in addition to using virgin pulp, used paper, used cloth, or the like may be reused. The cellulose-based filler may be obtained by coarsely crushing virgin pulp, used paper, used cloth, or the like with a shredder device or the like.

As the cellulose-based filler, a commercially available product may be used. Examples of the commercially available product of the fibrous cellulose-based filler include KC Flock W-80 and NP Fiber W-6 (all manufactured by Nippon Paper Industries Co., Ltd.). Examples of the commercially available product of the spherical cellulose-based filler include Viscopearl D-30 (manufactured by Rengo Co., Ltd.). As the cellulose-based filler, for example, Guaiba BEKP manufactured by CMPC processed with a flour milling machine or defibrated with a twin-screw kneader may be used.

The cellulose-based filler refers to a filler containing cellulose or a cellulose derivative. The cellulose-based filler may contain components other than cellulose or the cellulose derivative. Examples of the components other than cellulose or the cellulose derivative include hemicellulose and lignin. The cellulose-based filler may be subjected to a treatment such as bleaching. The cellulose-based filler may not contain the cellulose derivative. The cellulose-based filler may contain only cellulose without containing the cellulose derivative or the other components.

The average total length of the cellulose-based filler is preferably 500 μm or less, 400 μm or less, 300 μm or less, 200 μm or less, 150 μm or less, or 100 μm or less. As a result, thickening of the material during kneading is reduced, and heat generated by shearing is reduced, whereby discoloration of the molding material due to scorching of the cellulose-based filler is inhibited.

The average total length of the cellulose-based filler refers to an average of the longest dimension among the length, width, and height of the shape of the cellulose-based filler. That is, the average total length of the cellulose-based filler refers to an average of the maximum side length or an average of the maximum diameter of the cellulose-based filler. Specifically, when the shape of the cellulose-based filler is, for example, fibrous, the average total length is an average of the fiber length. When the shape is, for example, scaly, the average total length is an average of the long side length (the maximum side length). When the shape is, for example, spherical, the average total length is an average of the maximum diameter. The fiber length refers to a distance along the curvature when the fiber is curved. “Average” may be a number average, a length-weighted average, or a length-length-weighted average.

The average total length of the cellulose-based filler can be determined by the following method. For example, using a scanning electron microscope “S-4700” manufactured by Hitachi High-Tech Corporation, the average total length can be determined by performing ruler calibration in the SEM with a calibration standard sample “S2009T” manufactured by EM Japan Co., Ltd., and measuring the length of 100 cellulose-based fillers arbitrarily and randomly collected. In addition, using a particle shape image analysis apparatus “PITA-04” manufactured by Seishin Enterprise Co., Ltd., the average total length can be determined by setting 50 mL of a dispersion liquid of a sample adjusted to 0.05 to 0.1 wt % in the apparatus and performing measurement. The average fiber length of the cellulose-based filler when the cellulose-based filler is fibrous is obtained by a method conforming to ISO 16065-2:2007.

The total length distribution width ((D90 D10)/D50) of the cellulose-based filler is preferably 5.0 or less, 4.0 or less, 3.0 or less, 2.0 or less, or 1.5 or less. D10, D50, and D90 indicate the total lengths corresponding to 10%, 50%, and 90%, respectively, of a cumulative volumetric frequency calculated from the shorter total length of the cellulose-based filler.

The total length distribution width of the cellulose-based filler can be determined by the following method. For example, using “L&W Fiber Tester Plus” manufactured by ABB, the total length distribution width can be obtained by setting 300 mL of a dispersion liquid of a sample adjusted to 0.1 wt % in the apparatus and performing measurement. In addition, using a laser diffraction particle size distribution measuring apparatus “MT3300EXII” manufactured by MicrotracBEL, the total length distribution width can be obtained by setting 20 mL of a dispersion liquid of a sample adjusted to 0.05 to 0.1 wt % in the apparatus and performing measurement by a laser diffraction/Mie scattering method.

The crystal structure of the cellulose and/or the cellulose derivative contained in the cellulose-based filler is not particularly limited, and may be type I, type II, type III, type IV, or amorphous. The crystal structure is preferably type I in a fibrous cellulose-based filler, preferably type II in a spherical cellulose-based filler, and preferably amorphous in a scaly cellulose-based filler.

The crystallization rate of the cellulose and/or the cellulose derivative contained in the cellulose-based filler is preferably 50 to 90%, 55 to 80%, or 60 to 75%. The crystallization rate of the cellulose and/or the cellulose derivative can be calculated, for example, from each peak area (for example, 2θ=22.6° in cellulose type I and 2θ=20.2° in cellulose type II) obtained with a sealed X-ray tube (Cu, output: 40 kV, 40 mA) using an X-ray diffractometer “PANalytical X'PERT” manufactured by Malvern Panalytical Ltd.

The average aspect ratio of the cellulose-based filler is preferably 20 or less, 15 or less, 10 or less, 5 or less, or 1.5 or less. The average aspect ratio of the cellulose-based filler is preferably 1 or more. As a result, thickening of the material during kneading is reduced, and heat generated by shearing is reduced, whereby discoloration of the molding material due to scorching of the cellulose-based filler is inhibited.

The aspect ratio of the cellulose-based filler is the ratio between two longer dimensions among the length, width, and height dimensions of the cellulose-based filler. Specifically, when the cellulose-based filler is fibrous, the aspect ratio is a value obtained by dividing the fiber length by the fiber width. When the cellulose-based filler is scaly, the aspect ratio is a value obtained by dividing the long side length (the maximum side length) by the width side length. When the cellulose-based filler is spherical, the aspect ratio is a value obtained by dividing the longest diameter among the length, width, and height dimensions of the cellulose-based filler by the second longest diameter. The thickness direction is not taken into consideration in the calculation of the aspect ratio.

The aspect ratio of the cellulose-based filler can be determined by the same measurement method as that for the average total length of the cellulose-based filler. The average aspect ratio is an average of the aspect ratios of 100 cellulose-based fillers arbitrarily and randomly collected.

The content of the cellulose-based filler is preferably 10% by mass or more, 20% by mass or more, or 30% by mass or more with respect to the total amount of the molding material. As a result, the elasticity of the molded article tends to be further improved. When the content of the cellulose-based filler is large, the number of interfaces between the cellulose-based filler and the elastomer increases, and the risk of interfacial peeling increases. However, in the present embodiment, since the above-described ratio L/A is 60 or more, interfacial peeling is inhibited, and thus interfacial peeling is unlikely to occur even when the content of the cellulose-based filler is large to some extent. The content of the cellulose-based filler is preferably 60% by mass or less, 50% by mass or less, or 40% by mass or less with respect to the total amount of the molding material. As a result, the contents of the elastomer and the highly polar polyester are ensured, and both the impact resistance and the elasticity of the molded article tend to be achieved at a higher level.

The content of the cellulose-based filler can be measured by quantitatively determining the weight of a residue obtained by dissolving the molding material in a chloroform solvent and quantitatively determining the amount of the cellulose-based filler in the residue by fluorescent X-ray analysis. For the fluorescent X-ray analysis, for example, “JSX-1000S” manufactured by JEOL Ltd. can be used.

### 1.4. Inorganic Filler

The molding material of the present embodiment may contain an inorganic filler. The inorganic filler functions as a filling material or a coloring material in the molding material and the molded article. In addition, the inorganic filler tends to improve the elasticity of the molded article.

Examples of the inorganic filler include particles made of inorganic materials such as metals such as aluminum; silicates such as clay, talc, mica, kaolin, zeolite, calcium silicate, montmorillonite, and bentonite; oxides such as silica, diatomaceous earth, aluminum oxide, zirconium oxide, barium ferrite, barium oxide, and pumice; hydroxides such as aluminum hydroxide, magnesium hydroxide, and basic magnesium carbonate; carbonates such as calcium carbonate, magnesium carbonate, dolomite, and dawsonite; sulfates such as calcium sulfate and barium sulfate; and sulfites such as calcium sulfite. The inorganic filler may be a fiber made of an inorganic material such as a glass fiber.

As the inorganic filler, a commercially available product may be used. Examples of the commercially available product of the inorganic filler include G-120 (manufactured by Sankyo Seifun Co., Ltd.), which is ground calcium carbonate, precipitated calcium carbonate coarse particles (manufactured by Maruo Calcium Co., Ltd.), and Hindalco FH22D (manufactured by Hindalco Industries Ltd.), which is aluminum hydroxide.

The volume average particle size of the inorganic filler is preferably 0.1 to 100 μm, 0.1 to 50 μm, or 0.1 to 10 μm.

The content of the inorganic filler, if contained, is preferably 1% by mass or more, 5% by mass or more, or 10% by mass or more with respect to the total amount of the molding material. As a result, the elasticity of the molded article tends to be further improved. When the content of the inorganic filler is large, the number of interfaces between the inorganic filler and the elastomer increases, and the risk of interfacial peeling increases. However, in the present embodiment, since the above-described ratio L/A is 60 or more, interfacial peeling is inhibited, and thus interfacial peeling is unlikely to occur even when the content of the inorganic filler is large to some extent. The content of the inorganic filler, if contained, is preferably 30% by mass or less, 27% by mass or less, or 25% by mass or less with respect to the total amount of the molding material. As a result, the contents of the elastomer and the highly polar polyester are ensured, and both the impact resistance and the elasticity of the molded article tend to be achieved at a higher level.

The total content of the cellulose-based filler and the inorganic filler is preferably 20% by mass or more, 25% by mass or more, 30% by mass or more, or 35% by mass or more with respect to the total amount of the molding material. As a result, the elasticity of the molded article tends to be further improved. When the total content of the cellulose-based filler and the inorganic filler is large, the number of interfaces between the cellulose-based filler and the inorganic filler and the elastomer increases, and the risk of interfacial peeling increases. However, in the present embodiment, since the above-described ratio L/A is 60 or more, interfacial peeling is inhibited, and thus interfacial peeling is unlikely to occur even when the total content of the cellulose-based filler and the inorganic filler is large to some extent. The total content of the cellulose-based filler and the inorganic filler is preferably 60% by mass or less, 55% by mass or less, 50% by mass or less, or 45% by mass or less with respect to the total amount of the molding material. As a result, the contents of the elastomer and the highly polar polyester are ensured, and both the impact resistance and the elasticity of the molded article tend to be achieved at a higher level.

### 1.5. Flame Retardant

The molding material of the present embodiment may contain a flame retardant. Examples of the flame retardant include a phosphazene derivative and a phosphate derivative.

The phosphazene derivative is a compound having a phosphazene skeleton in the molecular structure. The phosphazene skeleton refers to a cyclic or chain molecular structure in which phosphorus atoms and nitrogen atoms are alternately bonded. Examples of the phosphazene derivative include hexachlorocyclotriphosphazene, hexabromocyclotriphosphazene, cyclotrichlorotriphenoxytriphosphazene, cyclohexaphenoxytriphosphazene, cyclotrichlorotrimethoxytriphosphazene, and compounds having a linear molecular structure formed by ring-opening of these structures. As the phosphazene derivative, a commercially available product may be used. Specific examples of the commercially available product of the phosphazene derivative include Rabitle (registered trademark) FP-110 and FP-100, product names from Mitsui Fine Chemicals, Inc.

The phosphate derivative is a compound having a phosphate skeleton in the molecular structure. The phosphate skeleton is a structure in which one or more hydrogen atoms of three hydroxy groups of phosphoric acid are substituted with an organic group. Examples of the phosphate derivative include triphenyl phosphate, tris(isopropylphenyl)phosphate, diphenylmonohexyl phosphate, diphenylammonium phosphate, diphenylaluminum phosphate, and compounds such as a bis body or a polymer having a structure in which the same phosphoric acid units are repeatedly present or a structure in which the same phosphoric acid units are crosslinked with a diol compound. As the phosphate derivative, a commercially available product may be used. Examples of the commercially available product of the phosphate derivative include Exolit (registered trademark) OP1230, OP1240, OP1312, OP1400, and OP930 from Clariant and ADK STAB (registered trademark) FP-600, FP-900L FP-2100JC, FP-2500S, FP-2600U, and PFR from ADEKA Corporation.

Since the phosphazene derivative and the phosphate derivative exhibit flame retardancy with a relatively small amount, the influence on the impact resistance and the elasticity of the molded article can be inhibited. The phosphazene derivative and the phosphate derivative have higher dispersibility in the molding material or the molded article than other flame retardants. Therefore, the phosphazene derivative and the phosphate derivative are unlikely to form aggregates in the molded article, and tend to have a small influence on the physical properties of the molded article.

The content of the flame retardant, if contained, is preferably 1 to 30% by mass, 5 to 27% by mass, or 10 to 25% by mass with respect to the total amount of the molding material. As a result, the influence on the impact resistance and the elasticity of the molded article can be inhibited while exhibiting flame retardancy.

The dispersed state of the flame retardant is preferably such that the number of flame retardant aggregates per 1 cm² is 1 or less in an arbitrary cross section of the molding material. The dispersed state of the flame retardant can be observed by, for example, elemental mapping analysis using a scanning electron microscope or the like.

### 1.6. Other Components

The molding material of the present embodiment may contain, for example, components such as a colorant, an insecticide, a fungicide, an antioxidant, an ultraviolet absorber, an aggregation inhibitor, a mold release agent, and a resin other than the highly polar polyester.

### 2. Method for Producing Molding Material

The method for producing a molding material of the present embodiment includes a kneading step of kneading an elastomer, a highly polar polyester, and a cellulose-based filler to obtain a molding material, wherein in the kneading step, the elastomer is dispersed such that an average short side length A of the elastomer in an arbitrary cross section of the molding material is 2 μm or less, and a ratio L/A of an area-weighted average perimeter L to the average short side length A of the elastomer is 60 to 200.

For kneading, a single-screw kneader may be used or a twin-screw kneader may be used. The kneaded molding material is extruded from the kneader, for example, in a strand shape. The twin-screw kneader may mainly include, for example, kneading disks of 15 to 30% of the entire screw and a leading disk. As the kneading disks, for example, forward twisted, neutral, and reverse twisted disks are used, and the number of blades in one disk is, for example, 1 to 5. A disk shape having a notch or a projection shape and having excellent stirring power, a reverse twisted leading disk, a kneading disk having an inclined outer periphery, or the like may be used. The barrel temperature is preferably 200 °C or lower, and more preferably 180 °C or lower in order to prevent poor color mixing due to cellulose burning or decomposition, the occurrence of silver streaks on the surface of the molded article, deterioration in physical properties, and the like. The temperature control may be changed, for example, by applying a temperature gradient to each barrel unit or each head or die.

The molding material after kneading may be molded into a pellet shape by pelletizing. The molding material after kneading may be accumulated in a sheet shape. Further, the sheet-shaped molding material may be cut into a desired shape with a shredder device and molded into a pellet shape. The shape of the pellet-shaped molding material is, for example, a substantially cubic shape of 2 to 5 mm³.

Since the molding material accumulated in a sheet shape contains a large amount of air and has a low density, the air may be removed with a calender device before cutting to compress the molding material and to increase the density. Further, it may be heated in a non-contact manner with a heating furnace and then heat pressed with a heat press device. In the heating furnace and the heat press device, heating is preferably performed at a temperature about 20 °C higher than the melting temperature of the thermoplastic component such as the highly polar polyester. As a result, a sheet in which each component is dispersed with a bias inhibited tends to be formed.

### 3. Uses of Molding Material

The molding material of the present embodiment can be suitably used in the production of molded articles such as various containers, sheets, housings for office equipment, and housings for home electric appliances as an alternative to polystyrene or the like. A known molding method such as injection molding or press working can be used for the production of molded articles using the molding material of the present embodiment.

### EXAMPLES

Hereinafter, the present disclosure will be described more specifically with reference to Examples and Comparative Examples. The present disclosure is not limited by Examples below any way.

### 1. Production of Molding Material

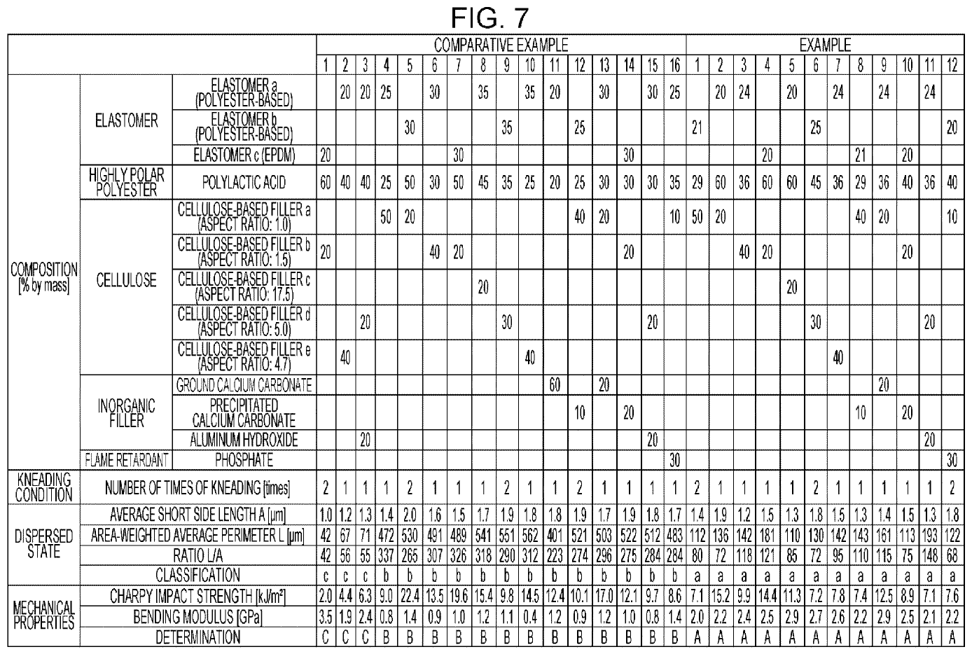

Each component was charged into a twin-screw kneader “KZW15TW-45MG” manufactured by Technovel Corporation and kneaded so as to have the compositions shown in the table of FIG. 7. The used twin-screw kneader mainly included kneading disks of 15 to 30% of the entire screw and a leading disk. The kneading disks were forward twisted, neutral, and reverse twisted disks, and the number of blades in one disk was 1 to 5. The kneading conditions included a maximum heating temperature of 180 °C and an extrusion discharge amount of 1 kg/hr. The number of times of kneading was 1 or 2 as shown in the table of FIG. 7. When the number of times of kneading was 2, the molding material extruded in the first kneading was charged into the twin-screw kneader again, and the second kneading was performed. The kneaded molding material was extruded in a strand shape. The kneaded molding material was molded into a pellet shape with a pelletizer. As a result, the molding materials of Comparative Examples 1 to 16 and Examples 1 to 12 were obtained.

The details of each component are as follows:
Elastomer a (polyester-based elastomer, Esterar ES-A60NX manufactured by Aronkasei Co., Ltd.)
Elastomer b (polyester-based elastomer, Esterar E-D42N manufactured by Aronkasei Co., Ltd.)
Elastomer c (olefin-based elastomer, EPDM, NOLDEL 3720P manufactured by Dow Toray Co., Ltd.)
Polylactic acid (highly polar polyester, Terramac TE-2000 manufactured by Unitika Ltd.)
Cellulose-based filler a (spherical cellulose, Viscopearl D-30 manufactured by Rengo Co., Ltd., average total length: 30 μm, average aspect ratio: 1.0, total length distribution width: 1.8, crystallization rate: 70 to 75%, type II crystal structure)
Cellulose-based filler b (scaly cellulose obtained by processing Guaiba BEKP manufactured by CMPC with KGW-G015 manufactured by West, average total length: 40 μm, average aspect ratio: 1.5, total length distribution width: 3.8, crystallization rate: 0 to 10%, amorphous)
Cellulose-based filler c (fibrous cellulose obtained by defibrating Guaiba BEKP manufactured by CMPC in a twin-screw kneader, average total length: 350 μm, average aspect ratio: 17.5, total length distribution width: 1.0, crystallization rate: 58 to 65%, type I crystal structure)
Cellulose-based filler d (fibrous cellulose, KC Flock W-80 manufactured by Nippon Paper Industries Co., Ltd., average total length: 200 μm, average aspect ratio: 5.0, total length distribution width: 3.5, crystallization rate: 63 to 67%, type I crystal structure)
Cellulose-based filler e (fibrous cellulose, NP Fiber W-6 manufactured by Nippon Paper Industries Co., Ltd., average total length: 10 μm, average aspect ratio: 4.7, total length distribution width: 1.5, crystallization rate: 65 to 69%, type I crystal structure)
Ground calcium carbonate (inorganic filler, G-120 manufactured by Sankyo Seifun Co., Ltd.)
Precipitated calcium carbonate (inorganic filler, precipitated calcium carbonate coarse particles manufactured by Maruo Calcium Co., Ltd.)
Aluminum hydroxide (inorganic filler, Hindalco FH22D manufactured by Hindalco Industries Ltd.)
Phosphate (flame retardant, ADK STAB FP-2500S manufactured by ADEKA Corporation)

For the average total length and the average aspect ratio of the cellulose-based filler, the number averages of the total length and the aspect ratio of each cellulose-based filler obtained by performing, using a scanning electron microscope “S-4700” manufactured by Hitachi High-Tech Corporation, ruler calibration in the SEM with a calibration standard sample “S2009T” manufactured by EM Japan Co., Ltd., and measuring the length of 100 cellulose-based fillers arbitrarily and randomly collected were employed.

### 2. Observation of Dispersed State of Elastomer

In accordance with Procedures 1 to 4 described above, the average short side length A and the area-weighted average perimeter L of the elastomer in an arbitrary cross section of the molding material were measured, and the ratio L/A was calculated. Each value was as shown in the table of FIG. 7.

More specifically, first, the molding material was cut, and an arbitrary cross section was photographed with an atomic force microscope to acquire an atomic force microscope image (Procedure 1).

Next, the atomic force microscope image data was binarized by threshold processing by the following procedure (Procedure 2).
Import the atomic force microscope image data into the image analysis software ImageJ.
Select Set Scale of the Analyze tab.
Enter the number of pixels of the cross-sectional image to Distance in Pixel.
Enter the distance of one side of the field of view of the cross-sectional image to Known Distance.
Enter the unit of the distance to Unit of Length.
Select Subtract Background of the Process tab.
Select the mark of Polygon selections on the menu screen of ImageJ.
Connect and enclose only the filler portion of the image by clicking.
Push Fill of the Edit tab to whiten the filler portion.
Do the same for all filler portions.
Select Threshold from Adjust of the Image tab, and perform binarization processing.

Next, the area-weighted average perimeter L, which is one of the shape parameters of the elastomer portion, was calculated using image analysis software ImageJ by the following procedure (Procedure 3).
Select Set Measurement of the Analyze tab.
Check Area and Perimeter.
Select Analyze Particle of the Analyze tab.
Check Display result and Add to Manager.
In the output window, for each elastomer portion, Area is displayed as the area and Perim as the perimeter.
Select all, copy, and paste to Microsoft Excel.
Calculate the area-weighted perimeter of each elastomer portion using the following expression:

area-weighted perimeter of each elastomer portion=perimeter of each elastomer portion×area of each elastomer portion/(total of areas of all elastomer portions) <Expression>

The sum of the area-weighted perimeter lengths of all elastomer portions is the area-weighted average perimeter length L.

Next, the short side of the elastomer portion was detected to determine the average short side length A by using the linear feature extraction function of the image analysis software by the following procedure (Procedure 4).
Select Ridge Detection from the Plugins tab.
Black and white of the binarized image are reversed.
The Ridge Detection window is displayed.
Check Estimate width and Preview.
A center line and a predicted outer frame appear on the inverted binarized image.
Adjust Line width, Sigma, Lower Threshold, and Upper Threshold so that they become an appropriate shape.
Length of the Result window is the short side length of the elastomer.
An average of Length excluding a value smaller than the length of 1 pixel as an inappropriate value is determined as the average short side length A.

Based on the average short side length A and the ratio L/A, the dispersed state of the elastomer was classified according to the following criteria. The classification results were as shown in the table of FIG. 7.
a: The average short side length A is 2 μm or less and the ratio L/A is 60 to 200.
b: The average short side length A is 2 μm or less and the ratio L/A is greater than 200.
c: The average short side length A is greater than 2 μm and/or the ratio L/A is less than 60.

### 3. Production of Test Molded Article

A test molded article was produced by injection molding using the molding material produced above. “THX40-5V” manufactured by Nissei Plastic Industrial Co., Ltd. was used as an injection molding apparatus. The heating temperature of the molding material in the injection molding was 200 °C. The shape of the test molded article had a rectangular plate shape with a long side of 80 mm±2 mm, a short side of 4.0 mm±0.2 mm, and a thickness of 10.0 mm±0.2 mm.

### 4. Evaluation of Impact Resistance

In conformity with ISO 179 (JIS K7111), the Charpy impact strength [kJ/m²] of the test molded article produced above was measured. “Impact Tester IT” manufactured by Toyo Seiki Seisaku-sho, Ltd. was used as a testing apparatus. The hammer weight was 4J (WR: 2.14 N/m). The lifting angle was 150°. The notch residual width was 8.0 mm±0.2 mm. The notch angle was 45°. The measurement results were as shown in the table of FIG. 7.

### 5. Evaluation of Elasticity

The bending modulus [GPa] of the produced test molded article was measured in conformity with ISO 178 (JIS K7171). “68TM-30” manufactured by Instron was used as a testing apparatus. The distance between the supports was 64 mm. The measurement results were as shown in the table of FIG. 7.

### 6. Determination of Mechanical Properties

Based on the Charpy impact strength and the bending modulus, the mechanical properties were determined according to the following criteria. The determination results were as shown in the table of FIG. 7.
A: The Charpy impact strength is 7 kJ/m² or more and the bending modulus is 2 GPa or more.
B: The Charpy impact strength is 7 kJ/m² or more and the bending modulus is less than 2 GPa.
C: The Charpy impact strength is less than 7 kJ/m².

### 7. Evaluation Results

It can be seen from the results shown in the table of FIG. 7 that a molded article that achieves both the impact resistance and the elasticity at a high level can be produced by the molding material of the present embodiment.

What is claimed is:

1. A molding material comprising:
an elastomer;
a highly polar polyester; and
a cellulose-based filler, wherein the elastomer is dispersed such that an average short side length A of the elastomer in an arbitrary cross section of the molding material is 2 μm or less, and a ratio L/A of an area-weighted average perimeter L to the average short side length A of the elastomer is 60 to 200.

2. The molding material according to claim 1, comprising an inorganic filler.

3. The molding material according to claim 2, wherein a total content of the cellulose-based filler and the inorganic filler is 20 to 60% by mass with respect to a total amount of the molding material.

4. The molding material according to claim 1, wherein a content of the cellulose-based filler is 20 to 50% by mass with respect to a total amount of the molding material.

5. The molding material according to claim 1, wherein an average aspect ratio of the cellulose-based filler is 5 or less.

6. The molding material according to claim 1, wherein the highly polar polyester contains polylactic acid.

7. A method for producing a molding material, the method comprising a kneading step of kneading an elastomer, a highly polar polyester, and a cellulose-based filler to obtain a molding material, wherein in the kneading step, the elastomer is dispersed such that an average short side length A of the elastomer in an arbitrary cross section of the molding material is 2 μm or less, and a ratio L/A of an area-weighted average perimeter L to the average short side length A of the elastomer is 60 to 200.
